(19) United States
(12) Patent Application Publication
(10) Pub. No.: US 2024/0135398 A1
(43) Pub. Date: Apr. 25, 2024

(54) INFORMATION PROCESSING APPARATUS

(71) Applicant: TOYOTA JIDOSHA KABUSHIKI KAISHA, Toyota-shi (JP)

(72) Inventors: Yu NAGATA, Tokyo-to (JP); Ibuki SHIMADA, Miyoshi-shi (JP); Toshihiro NAKAMURA, Shizuoka-ken (JP)

(73) Assignee: TOYOTA JIDOSHA KABUSHIKI KAISHA, Toyota-shi (JP)

(21) Appl. No.: 18/488,051

(22) Filed: Oct. 16, 2023

(30) Foreign Application Priority Data
Oct. 20, 2022 (JP) 2022-169478

(51) Int. Cl. G06Q 30/0203; B60W 60/00; G06Q 30/0282; G07C 5/00; G07C 5/08

(52) U.S. Cl. CPC G06Q 30/0203; B60W 60/0013; B60W 60/00253; G06Q 30/0282; G07C 5/008; G07C 5/0808; B60W 2556/45

(57) ABSTRACT

An information processing apparatus includes a controller configured to acquire questionnaire data including a score for each autonomous driving system installed in each vehicle among a plurality of vehicles operated by autonomous driving along a predetermined operation route, the score being an evaluation index of ride comfort of each vehicle, identify, based on an aggregate result of the questionnaire data, a vehicle from among the plurality of vehicles for which the score is determined to be less than a threshold as a first vehicle, and extract first data to be used in analyzing ride comfort from first vehicle information acquired by a first autonomous driving system, which is an autonomous driving system installed in the first vehicle.

### CROSS-REFERENCE TO RELATED APPLICATION

This application claims priority to Japanese Patent Application No. 2022-169478 filed on Oct. 21, 2022, the entire contents of which are incorporated herein by reference.

### TECHNICAL FIELD

The present disclosure relates to an information processing apparatus.

### BACKGROUND

Technology related to the ride comfort of vehicles operated by autonomous driving is known. For example, Patent Literature (PTL) 1 discloses technology for receiving answers to questions about ride comfort from passengers on board an autonomously controlled vehicle.

### CITATION LIST

### Patent Literature

PTL 1: JP 2020-052468 A

### SUMMARY

In passenger transportation services that use vehicles operated autonomously (autonomous vehicles), autonomous driving systems have been continuously improved in order to dispatch vehicles with better ride comfort. However, with conventional technology, vehicle information is analyzed by each system developer, making it difficult to optimize the entire service and leaving room for improvement.

It would be helpful to improve technology related to the ride comfort of autonomous vehicles.

An information processing apparatus including a controller configured to:
acquire questionnaire data including a score for each autonomous driving system installed in each vehicle among a plurality of vehicles operated by autonomous driving along a predetermined operation route, the score being an evaluation index of ride comfort of each vehicle;
based on an aggregate result of the questionnaire data, identify a vehicle, from among the plurality of vehicles, for which the score is determined to be less than a threshold as a first vehicle; and
extract first data to be used in analyzing ride comfort from first vehicle information acquired by a first autonomous driving system, which is an autonomous driving system installed in the first vehicle.

According to an embodiment of the present disclosure, technology related to the ride comfort of autonomous vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of a vehicle;

FIG. 3 is a block diagram illustrating a schematic configuration of an information processing apparatus;

FIG. 4 is a flowchart illustrating operations of an information processing apparatus according to a first embodiment; and

FIG. 5 is a flowchart illustrating operations of an information processing apparatus according to a second embodiment.

### DETAILED DESCRIPTION

Hereinafter, an embodiment of the present disclosure will be described.

(Outline of Embodiment)

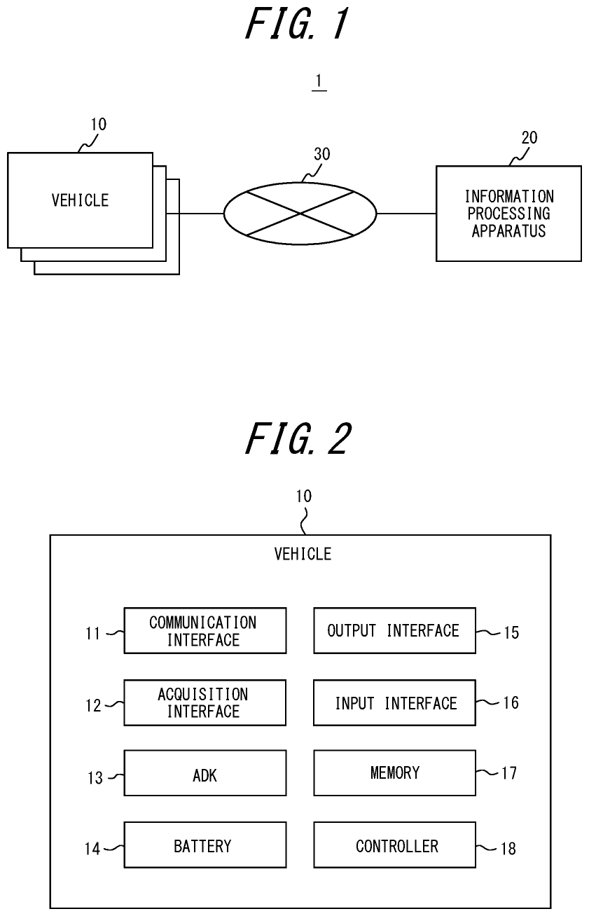

A system 1 according to an embodiment of the present disclosure will be outlined with reference to FIG. 1. The system 1 includes vehicles 10 and an information processing apparatus 20. The vehicles 10 and the information processing apparatus 20 are communicably connected to a network 30 including, for example, the Internet, a mobile communication network, or the like.

Each vehicle 10 is an automobile, for example, but is not limited to this and may be any vehicle that runs on charged energy. The automobile is, for example, a hybrid electric vehicle (HEV), a plug-in hybrid electric vehicle (PHEV), a battery electric vehicle (BEV), a fuel cell electric vehicle (FCEV), or the like, but is not limited to these. In the present embodiment, the vehicle is driven by a driver in a manual driving section and is automated at any level of operation in an autonomous driving section. The level of automation is, for example, one of level 1 to level 5 according to the classification of the Society of Automotive Engineers (SAE). The vehicle 10 may be a dedicated Mobility as a Service (MaaS) vehicle. An autonomous driving system that controls autonomous driving is installed in the vehicle 10. The autonomous driving system is an Autonomous Driving Kit (ADK) in the present embodiment, but this configuration is not limiting. In the present embodiment, the vehicle 10 is a semi-demand bus that makes at least one stop on an operation route in response to a request by the user, but this configuration is not limiting. The vehicle 10 moves along an operation route defined in an operation plan. When the operation plan is changed, the vehicle 10 moves along the operation route defined in the changed operation plan. The number of vehicles 10 included in the system 1 may be freely determined.

The information processing apparatus 20 is, for example, a computer such as a server apparatus. The information processing apparatus 20 can communicate with the vehicles 10 via the network 30. The information processing apparatus 20 can acquire any information about the vehicles 10, such as vehicle information from each vehicle 10.

The “vehicle information” is any information acquired from the vehicle 10. In the present embodiment, the vehicle information includes information that changes as the vehicle 10 travels. The information that changes as the vehicle 10 travels is, for example, at least one of the position of the vehicle 10, driving mode, acceleration, vehicle speed, distance traveled, electrical energy consumption, remaining battery capacity, shift position, operation status of accelerator or brake, operation status of steering wheel, or operation status of collision safety device. The vehicle information is not, however, limited to these examples, and may include, for example, information on the status of components or systems of the vehicle 10 (such as warning light display information or diagnostic information), the number of users boarding and alighting from the vehicle 10, or the time each piece of data was acquired (for example, a time stamp).

In the present embodiment, the system 1 is used in a passenger transportation service that uses a semi-demand bus as the vehicle 10.

First, an outline of the present embodiment will be described, and details thereof will be described later. The information processing apparatus 20 acquires questionnaire data including a score for each autonomous driving system installed in each vehicle 10 among a plurality of vehicles 10 operated by autonomous driving along a predetermined operation route, the score being an evaluation index of the ride comfort of each vehicle 10. Based on an aggregate result of the questionnaire data, the information processing apparatus 20 identifies a vehicle 10, from among the plurality of vehicles 10, for which the score is determined to be less than a threshold as a first vehicle. The information processing apparatus 20 extracts first data to be used in analyzing ride comfort from first vehicle information acquired by a first autonomous driving system, which is an autonomous driving system installed in the first vehicle.

According to the present embodiment, the first vehicle is thus identified from among a plurality of vehicles 10 based on the aggregate result of questionnaire data recorded for each autonomous driving system installed in each vehicle 10. The first data to be used in analyzing ride comfort is then extracted from the first vehicle information acquired by the first autonomous driving system installed in the first vehicle. By automating the extraction of data useful for analyzing ride comfort, for example, the burden associated with data extraction can be thus reduced for developers of autonomous driving systems who analyze ride comfort. As a result, the developers of autonomous driving systems will be able to extract, from vehicle information, data that is useful for analyzing ride comfort and identify points for improvement to autonomous driving systems. Accordingly, technology related to the ride comfort of autonomous vehicles is improved in that it will be easier to dispatch more comfortable vehicles efficiently.

Next, configurations of the system 1 will be described in detail.

<Configuration of Vehicle>

As illustrated in FIG. 2, each vehicle 10 includes a communication interface 11, an acquisition interface 12, an ADK 13, a battery 14, an output interface 15, an input interface 16, a memory 17, and a controller 18.

The communication interface 11 includes at least one communication interface for connecting to the network. The communication interface is compliant with mobile communication standards such as the 4th generation (4G) standard or the 5th generation (5G) standard, for example, but these examples are not limiting. In the present embodiment, the vehicle 10 communicates with the information processing apparatus 20 via the communication interface 11 and the network 30.

The acquisition interface 12 includes one or more apparatuses configured to acquire positional information for the vehicle 10. Specifically, the acquisition interface 12 includes a receiver corresponding to the Global Positioning System (GPS), for example, but is not limited to this and may include a receiver corresponding to any satellite positioning system. The acquisition interface 12 includes any sensor module capable of acquiring information on the vehicle 10 itself and information on the surroundings of the vehicle 10. For example, the sensor module may include a vibration sensor, an infrared sensor, a speed sensor, an angular velocity sensor, an acceleration sensor, a geomagnetic sensor, a temperature sensor, a power monitor, a distance sensor such as LiDAR (light detection and ranging), a camera, or combinations of these.

The ADK 13 is an Electronic Control Unit (ECU) that includes a computer with embedded autonomous driving software. The ADK 13 is configured to be capable of performing SAE levels 1 to 5, for example, as operational control of the vehicle 10. At least one of the sensor modules included in the acquisition interface 12 may be incorporated in the ADK 13. The vehicle 10 can drive autonomously according to driving control that can be performed by the ADK 13, which is used to transmit control requests to the controller 18, described below.

The battery 14 is a secondary cell that can be repeatedly charged and discharged. The vehicle 10 is driven by electrical energy supplied from the battery 14 to the motor and other drive mechanisms. The battery 14 may, for example, be a lithium-ion battery, a nickel-metal hydride battery, a lead-acid battery, or the like. In a wired or wireless manner, the battery 14 is connected to and charged by a charging apparatus installed at any charging base, such as a vehicle base provided by a bus operator.

The output interface 15 may include at least one output device for outputting information to notify the user of the information. The output device is a device such as a display for outputting information as images or video, a speaker for outputting information as audio, or the like, for example, but is not limited to these. The display is, for example, a liquid crystal display (LCD) or an organic electro luminescent (EL) display. The output interface 15 may include an interface for connecting to an external output device.

The input interface 16 includes at least one interface for input that detects user input. The interface for input is, for example, a physical key, a capacitive key, a pointing device, a touch screen integrally provided with the display, a microphone, or a camera. The input interface 16 may include an interface for connecting to an external input device. As an interface for connection, for example, an interface compliant with a standard such as Universal Serial Bus (USB) or Bluetooth® (Bluetooth is a registered trademark in Japan, other countries, or both) can be used.

The memory 17 includes one or more memories. The memories are semiconductor memories, magnetic memories, optical memories, or the like, for example, but are not limited to these. The memories included in the memory 17 may each function as, for example, a main memory, an auxiliary memory, or a cache memory. The memory 17 stores any data used for the operations of the vehicle 10. For example, the memory 17 may store a system program, an application program, embedded software, map information, and the like. The map information may include any geospatial information, such as a numerical map (including basic map information, numerical elevation data, and the like) provided by the Geospatial Information Authority of Japan. The information stored in the memory 17 may be updated with, for example, information acquired from the network 30 via the communication interface 11.

In the present embodiment, the memory 17 stores questionnaire data acquired via the input interface 16 of the vehicle 10. The questionnaire data can be stored in the memory 17 for each vehicle 10, i.e., for each autonomous driving system installed in each vehicle 10.

The controller 18 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 18 controls operations of the entire vehicle 10.

In the present embodiment, the controller 18 can perform autonomous driving of the vehicle 10 in response to a control request from the ADK 13. For example, the controller 18 can switch the operation mode of the vehicle 10, i.e., manual driving or autonomous driving, by setting the ADK 13 to ON in the autonomous driving section and OFF in the manual driving section.

In the present embodiment, the controller 18 transmits the vehicle information, acquired via the acquisition interface 12, in association with the vehicle 10, i.e., the autonomous driving system, to the information processing apparatus 20 via the communication interface 11 and the network 30. The controller 18 also transmits the questionnaire data stored in the memory 17 to the information processing apparatus 20 in association with the vehicle 10, i.e., the autonomous driving system. The controller 18 can also acquire information from the battery 14 indicating the electrical energy consumption and the remaining battery capacity.

<Information Processing Apparatus Configuration>

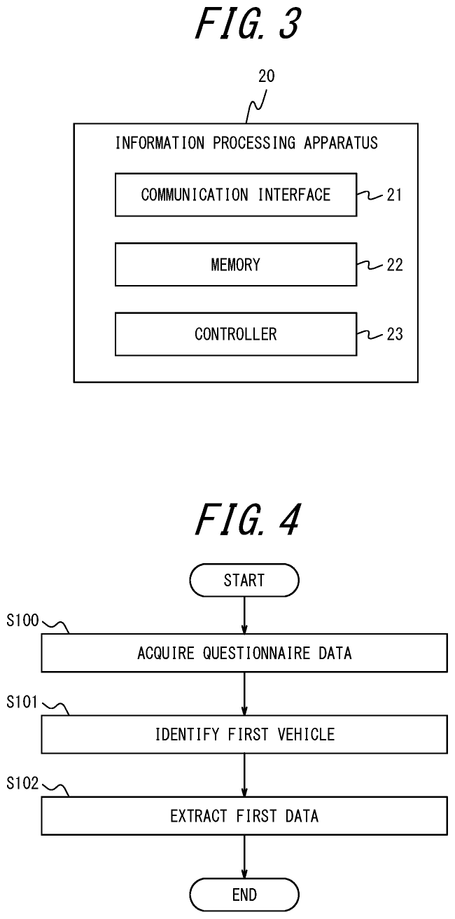

As illustrated in FIG. 3, the information processing apparatus 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 via the communication interface 21 and the network 30.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 30 via the communication interface 21.

The controller 23 includes at least one processor, at least one programmable circuit, at least one dedicated circuit, or a combination of these. The controller 23 controls the operations of the entire information processing apparatus 20.

In the present embodiment, the controller 23 receives the vehicle information for the vehicle 10 from the communication interface 11 of the vehicle 10 via the communication interface 21 and the network 30. The controller 23 also receives the questionnaire data for the vehicle 10 from the communication interface 11 of the vehicle 10. The controller 23 stores the received vehicle information and questionnaire data in a database of the memory 22 for each vehicle 10, i.e., for each autonomous driving system installed in each vehicle 10.

<Flow of Operations of Information Processing Apparatus>

Operations of the information processing apparatus 20 according to the first embodiment will be described with reference to FIG. 4. The operations in FIG. 4 correspond to a method according to the present embodiment. The operations in FIG. 4 are performed repeatedly, for example, at a predetermined period. The predetermined period can be freely determined.

Step S100: the controller 23 of the information processing apparatus 20 acquires questionnaire data including a score for each autonomous driving system (here, ADK 13) installed in each vehicle 10 among a plurality of vehicles 10 operated by autonomous driving along a predetermined operation route, the score being an evaluation index of the ride comfort of each vehicle 10.

Any method can be used to acquire the questionnaire data. For example, the questionnaire data can be acquired through a questionnaire using a touch screen as the input interface 16 of the vehicle 10. The touch screen of the user's terminal apparatus may be used in the questionnaire. For example, when arriving within a predetermined distance from a drop-off stop designated by the user, a question and a response button regarding the ride comfort of the vehicle 10 may be displayed on the touch screen, and the user's response may be acquired by having the user tap the response button. The user's response is acquired once per ride in the present embodiment but may be acquired multiple times. The user's response includes a score, which is an evaluation index of the ride comfort of the vehicle 10. The score is indicated by a grade (5-level evaluation) in the present embodiment, although any index can be adopted. The grade can be defined freely, but in the present embodiment, the grade is defined as “score 5: very good”, “score 4: good”, “score 3: normal”, “score 2: poor”, and “score 1: very poor”. In other words, a higher score indicates a better ride as perceived by the user. The controller 18 of the vehicle 10 transmits information, including the acquired score, to the information processing apparatus 20 via the network 30 as the questionnaire data for the vehicle 10.

The controller 23 of the information processing apparatus 20 may store the received questionnaire data for each vehicle 10 in the database of the memory 22. The questionnaire data can be stored in the database in association with identification information for the vehicle 10 (for example, the vehicle identification number). The questionnaire data can be stored in the database in association with identification information for a user (for example, the user account) and identification information for the vehicle 10 (for example, the vehicle identification number). In other words, the questionnaire data can be stored in a database for each vehicle 10, i.e., for each autonomous driving system (here, ADK 13) installed in each vehicle 10, in association with a user. Although the database is constructed in the memory 22 here, the database may be constructed in an external storage and connected to the information processing apparatus 20.

The controller 23 can thereby record the questionnaire data for each autonomous driving system by storing the questionnaire data in the memory 22 in association with each vehicle 10. The controller 23 can retrieve the questionnaire data by reading the questionnaire data from the database of the memory 22 each time the controller 23 executes the operations in FIG. 4. The controller 23 can search the database using the identification information for the vehicle 10 as a query and refer to the corresponding vehicle information and questionnaire data to recognize how the vehicle 10, i.e., the autonomous driving system, was evaluated by the user.

Step S101: based on an aggregate result of the questionnaire data acquired in step S100, the controller 23 identifies a vehicle 10, from among the plurality of vehicles 10, for which the score is determined to be less than a threshold as a first vehicle. The autonomous driving system installed in each vehicle 10 is assumed to remain the same, without being replaced throughout the questionnaire data aggregation period. In other words, the questionnaire data for each vehicle 10 aggregated over a certain period of time represents the evaluation result of one autonomous driving system installed in the vehicle 10.

Any method can be used to aggregate the questionnaire data. For example, the controller 23 may calculate the total score for a predetermined aggregation period by referring to the questionnaire data for each vehicle 10 and calculate a representative value for the score of each vehicle 10. The representative value can be freely defined but is assumed here to be the average value (“average score”). In this case, the controller 23 can calculate the average score as the average of the scores assigned by users who rode in each vehicle 10 during a predetermined aggregation period (for example, the past year). The controller 23 can identify the first vehicle based on the average score. Any method can be employed to identify the first vehicle. For example, the controller 23 can identify a vehicle 10 with an average score below the threshold as the first vehicle. The threshold can be set freely, but here the threshold is set to 3.0. The controller 23 identifies the vehicle 10, from among the plurality of vehicles 10, for which the score was determined to be less than 3.0 as the first vehicle.

Step S102: the controller 23 extracts first data to be used in analyzing ride comfort from first vehicle information acquired by a first autonomous driving system, which is an autonomous driving system installed in the first vehicle. The process then ends. The “first vehicle information” refers to the vehicle information acquired by the first autonomous driving system.

The first data is data indicating at least one of the position, driving mode, distance traveled, electrical energy consumption, remaining battery capacity, acceleration, vehicle speed, shift position, operation status of accelerator or brake, operation status of steering wheel, or operation status of collision safety device of the first vehicle. The controller 23 extracts the first data, from the vehicle information acquired by the first automated driving system during a predetermined aggregation period, by excluding data of a partial period. While the partial period can be set freely, first and second examples are illustrated below as specific examples.

As a first example, the partial period is the period during which the first vehicle was operated by manual driving in a predetermined aggregation period. The controller 23 can extract the first data, from the vehicle information acquired by the first autonomous driving system, by excluding the data for the period (first period) when the first vehicle was operated by manual driving. The first period can be identified by any method. For example, the controller 23 may acquire information indicating the driving mode of the vehicle 10 (“driving mode information”) from the vehicle information acquired by the first autonomous driving system during the questionnaire data aggregation period. From the driving mode information, the controller 23 can identify the time at which the ADK 13 of the vehicle 10 was set to ON or OFF, i.e., the time at which the operation mode of the vehicle 10 was set to manual driving. For example, suppose that the driving mode information indicates that the ADK 13 of the vehicle 10 was set to OFF from time T1 to time T2. In this case, the controller 23 identifies the time from T1 to T2 as the first period. The controller 23 extracts the first data, from the vehicle information acquired by the first automated driving system, by excluding data of the first period. The first data according to the first example can be considered to be the vehicle information for the autonomous driving section. Therefore, extracting the first data according to the first example facilitates the acquisition of data indicating the performance of the autonomous driving system, while excluding the driver's skill.

As a second example, the partial period is the period during which the first vehicle avoided danger in a predetermined aggregation period. In this case, the controller 23 can extract the first data, from the vehicle information acquired by the first autonomous driving system, by excluding the data for the period (second period) when the first vehicle avoided danger. The second period can be identified by any method. For example, the controller 23 may acquire information indicating the operation status of a collision safety device (“PCS information”), included in data regarding the driving status of the vehicle 10, from the vehicle information acquired by the first autonomous driving system during the questionnaire data aggregation period. The controller 23 can identify, from the PCS information, the time at which the collision safety device of the vehicle 10 was activated. For example, assume that the PCS information indicates that the collision safety device of the vehicle 10 was activated from time T3 to time T4. In this case, the controller 23 identifies the time from T3 to T4 as the second period. The controller 23 extracts the first data, from the vehicle information acquired by the first automated driving system, by excluding data of the second period. The first data according to the second example can be considered to be the vehicle information for the period when sudden deceleration behavior, such as sudden braking, was practiced to avoid danger in unavoidable circumstances. From the standpoint of safe operation, it is appropriate to exclude data under such circumstances from the evaluation of ride comfort. Therefore, extracting the first data according to the second example facilitates the acquisition of data indicating the performance of the autonomous driving system, while excluding data for a period in which the first vehicle avoided danger. In a case in which the acquisition time of the questionnaire is known, a questionnaire for a ride period including the period when the first vehicle avoided danger may be excluded from aggregation.

In this way, according to the first embodiment, technology related to the ride comfort of autonomous vehicles is improved in that it is easier to extract, from vehicle information, data useful for analyzing ride comfort and to identify points for improvement in an autonomous driving system.

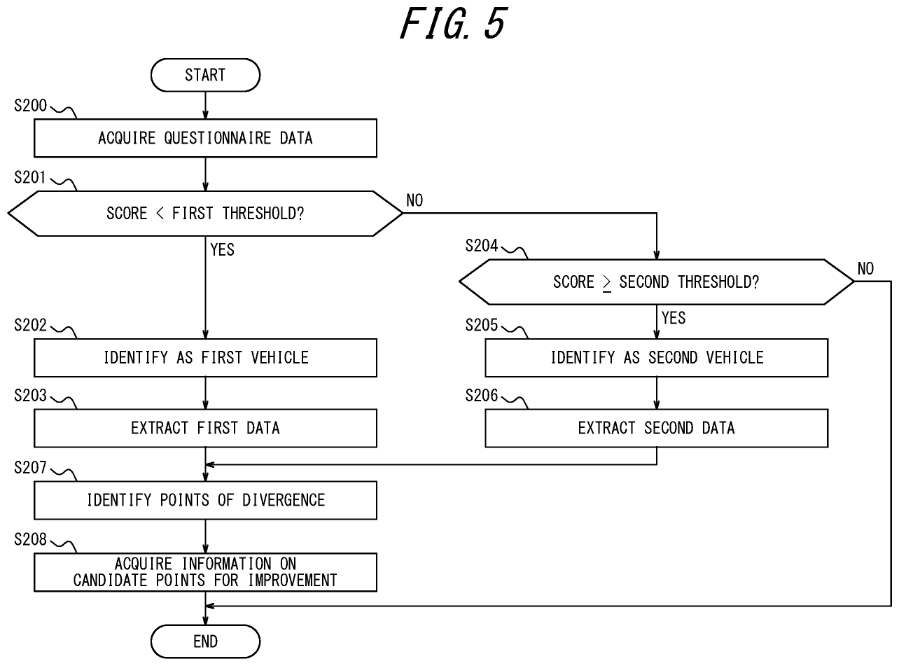

Operations of the information processing apparatus 20 according to the second embodiment are described next with reference to FIG. 5. The operations in FIG. 5 correspond to a method according to the present embodiment. The operations in FIG. 5 are performed repeatedly, for example, over a predetermined period. The predetermined period can be freely determined.

Step S200: the controller 23 of the information processing apparatus acquires questionnaire data for each autonomous driving system installed in each vehicle 10 among the plurality of vehicles 10. The process for acquiring the questionnaire data is similar to the above-described process in step S100, and thus a description is omitted.

Step S201: based on an aggregate result of the questionnaire data recorded in step S200, the controller 23 determines whether, among the plurality of vehicles 10, the score that is an evaluation index of ride comfort is less than a threshold. The threshold is the same as the threshold described above in step S101 and is 3.0 here. In the present embodiment, this threshold is also referred to as the “first threshold”.

Step S202: in a case in which the score is determined to be less than the first threshold (step S201: Yes), the controller 23 identifies the vehicle 10 for which the score was determined to be less than the first threshold as the first vehicle.

Specifically, the controller 23 identifies a vehicle 10, from among the plurality of vehicles 10, for which the score was determined to be less than 3.0 as the first vehicle. By executing steps S201 and S202, based on the aggregate result of the questionnaire data, the controller 23 identifies each vehicle 10, from among the plurality of vehicles 10, for which the score, which is an evaluation index of ride comfort, is determined to be less than the first threshold (here, 3.0) as the first vehicle.

Step S203: the controller 23 extracts the first data to be used in analyzing ride comfort from the first vehicle information. The process for extracting the first data is similar to the above-described process in step S102, and thus a description is omitted.

Step S204: in a case in which the score is determined to be equal to or greater than the first threshold (step S201: No), the controller 23 makes an excellent vehicle determination. The “excellent vehicle determination” refers to the process of determining whether there is a vehicle 10 for which the score is equal to or greater than a second threshold among the vehicles 10 for which the score was determined to be equal to or greater than the first threshold. In a case in which, as a result of the superior vehicle determination, it is determined that there is a vehicle 10 with a score equal to or greater than the second threshold (step S204: Yes), the process proceeds to step S205. Conversely, in a case in which it is determined that no vehicle 10 has a score equal to or greater than the second threshold (step S204: No), the process ends.

The second threshold can be set to any value that is equal to or greater than the first threshold and facilitates the extraction of vehicles 10, from among the plurality of vehicles 10, that exhibit excellent performance and can serve as a model for activities to improve the autonomous driving system (here, the ADK 13). It suffices to set the second threshold to an appropriate value equal to or greater than the first threshold. For example, in a case in which 3.0 is set as the first threshold, as in the present embodiment, 4.0 may be set as the second threshold. In this case, the controller 23 can make the excellent vehicle determination by determining whether there is a vehicle 10 for which the score was determined to be 4.0 or higher among the vehicles 10 for which the score was determined to be 3.0 or higher based on the aggregate result of the questionnaire data.

Step S205: the controller 23 identifies each vehicle 10 for which the score was determined to be equal to or greater than the second threshold as an excellent vehicle. The excellent vehicle corresponds to the second vehicle in the present embodiment.

Specifically, the controller 23 identifies a vehicle 10 for which the score was determined to be equal to or greater than the second threshold (for example, 4.0), among the vehicles 10 for which the score was determined to be equal to or greater than the first threshold, as the second vehicle. By executing steps S201, S204, and S205, based on the aggregate result of the questionnaire data, the controller 23 identifies each vehicle 10, from among the plurality of vehicles 10, for which the score, which is an evaluation index of ride comfort, is determined to be equal to or greater than the second threshold as the second vehicle.

Step S206: the controller 23 extracts second data to be used in analyzing ride comfort from second vehicle information acquired by a second autonomous driving system, which is an autonomous driving system installed in the second vehicle (excellent vehicle). The “second vehicle information” refers to the vehicle information acquired by the second autonomous driving system.

The second data is data indicating at least one of the position, driving mode, distance traveled, electrical energy consumption, remaining battery capacity, acceleration, vehicle speed, shift position, operation status of accelerator or brake, operation status of steering wheel, or operation status of collision safety device of the second vehicle. In the present embodiment, the second data is the same data items as the first data extracted in step S203. For example, in a case in which the first data extracted in step S203 is data indicating the “position” and “acceleration” of the first vehicle, the second data is data indicating the “position” and “acceleration” of the second vehicle. In this case, the controller 23 extracts, from the vehicle information acquired by the second autonomous driving system, data indicating the position of the second vehicle and data indicating the acceleration of the second vehicle as the second data.

Step S207: the controller 23 compares the first data extracted in step S203 with the second data extracted in step S206 to identify points of divergence.

Any method can be employed to identify the points of divergence. For example, the controller 23 may compare the first data and the second data based on the magnitude of fluctuation in the acceleration (“amplitude of acceleration”) or the frequency of fluctuation in the acceleration per unit time (“frequency of acceleration/deceleration”) for the first vehicle and the second vehicle. Since each vehicle 10 operates along a predetermined operation route in the present embodiment, the vehicle information for the first vehicle and the second vehicle includes data acquired at each position on the predetermined operation route. Therefore, the controller 23 can compare the performance of each automated system (here, the ADK 13) at the same position on the operation route by comparing the first data and the second data.

In the example described above in step S206, the controller 23 can compare the amplitude of acceleration or frequency of acceleration/deceleration of the first vehicle and the second vehicle at the same position on the operation route by comparing the first data and the second data. The controller 23 can output the result of comparison as, for example, the result of comparing the vehicle sway of the first vehicle and the second vehicle. For example, the controller 23 may freely set a threshold for the allowable deviation in the amplitude of acceleration or the frequency of acceleration/deceleration. In this case, the controller 23 compares each data point (each measurement acquired at a predetermined sampling rate) of the data indicating the acceleration of the first vehicle and the data indicating the acceleration of the second vehicle. Based on the result of comparison, the controller 23 can identify the data points for which the deviation at the same position on the operation route is equal to or greater than the threshold as singularities with a large deviation, i.e., as the points of divergence in the present embodiment.

When extracting the second data in step S206 above, the controller 23 may exclude data for the period corresponding to the first period or second period, as in the case of the first example or second example described above. In a case in which this yields in an unusable period for which data cannot be compared, the controller 23 can identify the points of divergence by comparing data for the period excluding the unusable period.

Step S208: the controller 23 acquires information on candidate points for improvement to the first autonomous driving system based on the points of divergence identified in step S207.

Specifically, the controller 23 refers to the database of the memory 22 to identify the time at which a data point as a deviation point was acquired and the corresponding position on the operation route. The controller 23 acquires information associating the identified time and position with the point of divergence. For example, in a case of detection of a data point such that the acceleration of the first vehicle is large enough compared to that of the second vehicle to be considered a singularity, the measurement time and corresponding position can be regarded as the time and position at which an abrupt operation, such as accelerating or braking, occurred in the first vehicle under conditions in which the collision safety device was not activated. As another example, in a case of detection of a data point such that the frequency of acceleration per unit time of the first vehicle is high enough compared to that of the second vehicle to be considered a singularity, the measurement time and corresponding position can be regarded as the time and position at which the accelerator was repeatedly switched ON/OFF in small increments, increasing the frequency of acceleration/deceleration of the first vehicle (so-called jerky driving). In both cases, the first vehicle (i.e., the ADK 13 thereof) is likely to be evaluated lower than the second vehicle (i.e., the ADK 13 thereof). Therefore, the controller 23 can treat such acquired information as information on candidate points for improvement to the first autonomous driving system.

In this way, the controller 23 can compare the first data and the second data to identify points of divergence, thereby acquiring information on candidate points for improvement to the first autonomous driving system.

In this way, according to the second embodiment, the acquired information on candidate points for improvement to the first autonomous driving system can be provided to the developers of the autonomous driving system installed in the first vehicle, for example, to facilitate identification of points for improvement to the autonomous driving system of the first vehicle.

As described above, the information processing apparatus 20 according to the present embodiment acquires questionnaire data including a score for each autonomous driving system installed in each vehicle 10 among a plurality of vehicles 10 operated by autonomous driving along a predetermined operation route, the score being an evaluation index of the ride comfort of each vehicle 10. Based on an aggregate result of the questionnaire data, the information processing apparatus 20 identifies a vehicle 10, from among the plurality of vehicles 10, for which the score is determined to be less than a threshold as a first vehicle. The information processing apparatus 20 extracts first data to be used in analyzing ride comfort from first vehicle information acquired by a first autonomous driving system, which is an autonomous driving system installed in the first vehicle.

According to this configuration, the first vehicle is thus identified from among a plurality of vehicles 10 based on the aggregate result of questionnaire data recorded for each autonomous driving system installed in each vehicle 10. The first data to be used in analyzing ride comfort is then extracted from the first vehicle information acquired by the first autonomous driving system installed in the first vehicle. By automating the extraction of data useful for analyzing ride comfort, for example, the burden associated with data extraction can be thus reduced for developers of autonomous driving systems who analyze ride comfort. As a result, the developers of autonomous driving systems will be able to extract, from vehicle information, data that is useful for analyzing ride comfort and identify points for improvement to autonomous driving systems. Accordingly, technology related to the ride comfort of autonomous vehicles is improved in that it will be easier to dispatch more comfortable vehicles 10 efficiently.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, in the above embodiment, when a user makes a reservation for a semi-demand bus as the vehicle 10, the user may be allowed to select a ride comfort mode (here modes 1 to 5) on a reservation application executed on the terminal apparatus of the user. In a case in which “mode 5” is selected, for example, a vehicle 10 with a high evaluation (for example, a score of 4 or higher) identified from the user's personal evaluation results may be dispatched. This facilitates vehicle dispatch based on the average evaluation score of an individual user (“past evaluation of individual user”), i.e., vehicle dispatch according to the preferences of the user who is the one making the reservation.

For example, in one variation of the above embodiment, the controller 23 of the information processing apparatus 20 can analyze the questionnaire data and identify users whose views deviate significantly from the overall evaluation, which is the average score of all users, as deviating users. For example, a user whose evaluation of the vehicle 10 (i.e., the ADK 13) for a certain operation service is at least a predetermined score (for example, 2.5) away from the overall evaluation for 50% or more of the user's responses may be identified as a deviating user. For example, in a case of detecting a user whose average evaluation score is 1.0 as the evaluation of a certain vehicle 10 as compared to an overall evaluation of 4.0, the controller 23 can identify that user as a deviating user. A vehicle 10 that the identified deviating users themselves evaluated highly in the past can be dispatched to the deviating users. Even a vehicle 10 that a user evaluated poorly once for some reason, however, may have a high overall evaluation. Therefore, the vehicle to dispatch may be determined for a deviating user based on the overall evaluation instead of the individual user's past evaluation, and the deviating user may be provided the opportunity to re-evaluate.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
acquire questionnaire data including a score for each autonomous driving system installed in each vehicle among a plurality of vehicles operated by autonomous driving along a predetermined operation route, the score being an evaluation index of ride comfort of each vehicle;
based on an aggregate result of the questionnaire data, identify a vehicle, from among the plurality of vehicles, for which the score is determined to be less than a threshold as a first vehicle; and
extract first data to be used in analyzing ride comfort from first vehicle information acquired by a first autonomous driving system, which is an autonomous driving system installed in the first vehicle.

2. The information processing apparatus according to claim 1,
wherein the controller is configured to identify, based on the aggregate result of the questionnaire data, a vehicle from among the plurality of vehicles for which the score, which is the evaluation index of ride comfort, is determined to be equal to or greater than a second threshold as a second vehicle, the second threshold being set to a value that is equal to or greater than a first threshold corresponding to the threshold,
extract second data to be used in analyzing ride comfort from second vehicle information acquired by a second autonomous driving system, which is an autonomous driving system installed in the second vehicle, and
acquire information that is a candidate point for improvement on the first autonomous driving system by comparing the first data and the second data to identify a point of divergence.

3. The information processing apparatus according to claim 2, wherein the first data includes information that changes as the first vehicle travels, and the second data includes information that changes as the second vehicle travels.

4. The information processing apparatus according to claim 1, wherein the controller is configured to extract the first data, from vehicle information acquired by the first autonomous driving system, by excluding data for a period in which the first vehicle was driven manually.

5. The information processing apparatus according to claim 1, wherein the controller is configured to extract the first data, from vehicle information acquired by the first autonomous driving system, by excluding data for a period in which the first vehicle avoided danger.
